(19) United States
(12) Patent Application Publication
(10) Pub. No.: US 2005/0039018 A1
(43) Pub. Date: Feb. 17, 2005

(54) Device for digital signature of an electronic document

(75) Inventor: Erland Wittkotter, Bunde (DE)

Correspondence Address: ALSTON & BIRD LLP;BANK OF AMERICA PLAZA, 101 SOUTH TRYON STREET, SUITE 4000, CHARLOTTE, NC, 28280-4000, US

(73) Assignee: BrainShield Technologies, Inc.

(21) Appl. No.: 10/759,986

(22) Filed: Jan. 16, 2004

Related U.S. Application Data
(63) Continuation of application No. PCT/EP02/08148, filed on Jul. 22, 2002.

(30) Foreign Application Priority Data
Jul. 20, 2001 (DE) DE 101 34 675.1

(51) Int. Cl. H04L 9/00

(52) U.S. Cl. 713/176

(57) ABSTRACT

The invention concerns a device for digital signature of an electronic document by means of a signature creation unit, protected against manipulation, and especially portable and card-like, which is provided for cooperation with a data processing unit offering the electronic document for signature and receiving the digital signature, and which is formed for deposit of a secrete, access-protected private signature encryption, where by the effect of a signature processor unit of the signature creation unit the digital signature on the basis of a signage string characteristic for the electronic document as well as the private digital signature encryption can be created, where the signature creation unit has an output unit, which is associated with it and which is not influenced by the data processing unit, for providing an output signal for a user of the data processing unit, where an input unit is associated with the signature creation unit, which can be confirmed by the user, and where the signature creation unit is formed in such a way, that in response to the output signal a user input into the input unit has to follow, before the digital signature is created and/or transmitted to the data processing unit.

### CROSS-REFERENCE TO RELATED APPLICATIONS

This is a continuation application of PCT/EP02/08148, filed Jul. 22, 2002, which is incorporated herein by reference in its entirety, and also claims the benefit of German Priority Application No. 101 34 675.1, filed Jul. 20, 2001, which is also incorporated herein by reference.

### BACKGROUND AND SUMMARY OF THE INVENTION

The following invention concerns a device for digital signature of an electronic document according to the enclosed claims.

Such a device is generally known from the state of the art and is typically (but not limited to it) implemented in an asymmetrical encrypting environment (i.e. through a cooperation of private and public encrypting). This technology is especially relevant since the passage of a so-called signature law, enacted in 1997 and updated in 2001, which recognized the generic digital signature as “electronic signature” and thus offers new possibilities, to realize the legal handwriting demand for certain will declarations through electronic means.

Thus, the device for digital signature known in the state of the art shows a signature creation unit, which at present typically is realized in the form of a so-called smart card, represented as a storage card containing a computer chip, whereby, as a separate card which is secure, a legal digital signature can be produced as a signature with the private signature encryption and a secure signature calculation unit contained in the card.

It is especially possible, to proof such a digital signature (namely the private digital signature encryption used on the characteristic signage of the electronic document) in an asymmetrical encryption environment by means of a public digital signature encryption for their legal use, where, in the terminology of German law, this public signature encryption is understood as a signature-proof encryption.

The technical basis for the principle of asymmetrical encryption according to the RSA process (named after its creators Rivest, Shamir and Adelman) is found in the idea, that the private digital signature encryption can be realized on the basis of large primary numbers, whereby the public as well as the private encryption is created by a product or function, respectively, of two large primary numbers. With the background, that the public and the private secrete encryption belong together functionally, that, however, the factoring of the public digital signature encryption into its prime factors by means of current technical methods and with a typical encryption length of 1000 bit (which corresponds to a number with 300 digits) is currently not possible within a realistic time frame by means of existing technology, in this way the desired asymmetrical encryption can be realized with a high degree of security and was thus accepted as the basis for digital signature.

However, this process as it is seen today is not completely without problems. Basically there is the question, if the secrete private signature encryption can be actually obtained by a computer factoring of the public encryption, that by means of software installed (often without the knowledge of the owner) in a suitable user environment within a data processing unit the signature creation unit is accessed illegally. Such programs, also used by hackers, in the form of a virus, run below the application level, without knowledge of the user, on the data processing unit, and, approximately parallel to an orderly signature process authorized by the user, illegally sign additional documents with illegal intention, without the user having knowledge of this, and especially without the possibility, to prevent such an illegal access of the data processing unit (which is per definition insecure) of the user. More than that, such a virus can intercept relevant warnings or such to the user on a deeper level, and can make the fact, that unauthorized signature processes run by means of the signature creation unit without the knowledge of the user, totally non-transparent. Since such a virus can also be controlled by remote network connection, dramatic security risks exist in regard to the authenticity and integrity of a document digitally signed in the established manner (and this before the background of the open question, who really has to guarantee the obviously necessary security).

A virus can simulate an error, such as the wrong password or PIN code, so as to force further entries by a user, without the ability of the user to verify that the first PIN code was correct and was only used for a non-authorized signature of a document.

Even certified (external) smart card readers can be manipulated. Thus, a second number pad can be added to the number pad of the card reader (where the PIN is entered), which can have the characteristic of capturing the input and then giving the user an error message, so that through an automatically initiated interim electro-mechanical input the first input of the PIN code can be misused, while the second input of the PIN code fools the user into thinking that the task has been completed correctly, with the result, that the user has faith, that the first input was indeed in error. This kind of manipulated smart card reader, can be installed especially in the public domain, without arousing suspicion, which shows the danger of how easily the digital signature can be misused for other purposes.

Another problematic area of the technology is found in the fact, that the signature creation unit, typically mobile and portable, can be stolen or otherwise misused. It is, however, usual, to secure the use of such smart cards by means of PIN numbers (similar to the process for debit or credit cards), but especially when the PIN is known, random misuse of the signature creation unit for digital signatures is possible, at least until the rightful user realizes the theft of a smart card and causes cancellation by notifying the certifying unit (typically a server unit), i.e. an automatic signal of an unauthorized user signal. Since the owner can claim, that the card can be regarded as stolen after a time period determined by him, all transactions between this point in time and the time of notification would be connected to unlawful use of the signature based on it in unknown numbers and under unknown circumstances. Thus the state of the art does not offer a solution, with which it can be quickly, that is at cancellation of the card, checked if the signature was actually misused during a questionable period, and if so, in what connection and from which sender. Because of the absence of such a factor, neither immediate decisions nor those based on good memory can be made, which make it possible for the signature owner to recall the processes which did not correspond to his expressed will and which will give the recipient the additional security, that a digital signature really originated from the signature owner.

A third problem complex inherent in the developing technology is found in the fact, that based on the actually foreseeable developments in connection with digital processors, there is the reasonable expectation, that within a time frame of 10 to 20 years processor units will be available, which enable the factorization of public digital signatures even of the present order of magnitude within realistic time frames (and thus immediately calculate from it the private digital signature encryption). A potentially relevant technology for this seems to be especially the theory of the so-called quantum computers, which is in the process of development and which reduces the exponential computing problem inherent in the encryption length of the public digital signature encryption to a substantially linear problem. In other words, even a super-proportional enlargement of the public digital signature encryption could be solved in the case of a decryption set-up by means of a quantum computer within a practically relevant time frame. This would have the effect, that the asymmetrical encryption process, perhaps according to the RSA model, can be assumed to be able to be decrypted according to the current legal conditions, not only with the danger, that such a signature generally would be considered unsafe in the future (and therefore not regarded as qualified according to the law), but also, with much more dangerous potential, that past documents with generic digital signatures can be subject to retroactive forgeries on the basis of decoded private digital signature encryptions. This would lead to a situation, where there would be no assurance at a future point in time, that a document drawn up in the past and digitally signed has the authenticity and integrity assured by the digital signature, with the corresponding consequences for the legal value of such a document (this is based on the principal problem of all digital information content, that it can, without variation or differentiation, be duplicated at will, and thus traditional methods of verification, perhaps for deviations, are per definition not possible).

It is thus the objective of the present invention, to improve a generic device for digital signature of an electronic document, especially in an asymmetrical encryption context, in view of its security against attacks by means of a virus or such, illegal access attempts running concealed on a user data processing line, but also in view of theft or other processes, such as removing a signature creation unit, or also in view of a possible future computerized discovery or publication of the private digital signature encryption from the public digital encryption.

The objective is achieved by the device with the characteristics of patent claim 1; independent security is claimed by the devices with the characteristics of patent claims 9, 14 and 19. Further advantageous developments of the invention result from the respective sub-claims, where, not considering a respective concrete back reference, such technically achievable and meaningful combinations of characteristics are considered to be included in the present invention, which are not directly mentioned as a back-referenced combination of sub-claims in the patent claims.

In an advantageous manner according to the invention, the issuing unit assigned to the signature creation unit makes it possible, that through the functional effect of the signature creation unit (and not through a data processing unit which could be infected by a virus) the output signal is made generic for the user, this output signal being in the form of a number, figure, letter, symbol or acoustical code, where in the manner according to the invention a user input over the input unit takes effect, and only as a response to such a correctly identified user input or by pressing a confirmation key the user signals, that a new digital signature (task) can be initiated, so that only the additionally protected digital signature for a document can be produced or given out, respectively, by means of the present invention. In other words, by means of the additional units added to the signature creation unit according to the invention, namely issuing unit and input unit, an additional security or control loop, respectively, is implemented with a user, by bypassing the data processing unit and thus also the possibility, that a corrupt program (virus or such) can take control over the signature creation process.

In this connection, each and every digital document available for a digital signature is considered an “electronic document”, not limited to papers, but including any digital form of expression such as structure, picture, sound, multimedia, games, program data or other digital data with content to be protected or signed, respectively. While until now a signature creation unit is realized in the form of so-called smart cards, other configurations are possible within the framework of the invention, perhaps in the form of cartridges, modules or other realization forms, which allow especially user-friendly implementation of the output and input units according to the invention.

As a “characteristic signage chain” in the framework of the present invention, not only the hash value calculated by known algorithms is recognized, but any other signage strings can be used a such a signage chain, which only enable in a sufficiently exact manner an identification of the content of the respective electronic document (about the attribute of the relative uniqueness and collision freedom of such a signage chain). In the following, hash value is considered as the characteristic signage chain.

As mentioned before, the output signal can take on any form. Besides an output to be realized typically by means of a suitable digital signal of a letter or number code (which simply would have to be entered by the user into the input unit in a simple realization form) other configurations, especially acoustical ones, can be used. The present invention also includes providing the input unit immediately on or at the (preferably modular) signature creation unit, alternatively this input unit can be realized by a keypad or another, already present input medium. The input is then a manual, i.e. done by a person, response to an output signal of the data processing unit, which notifies a person, that a subsequent input or interaction has to be performed by the person.

Even when the present invention is not limited to an asymmetrical encryption context, an especially preferred configuration (best mode) is in the area of the known asymmetrical encryption. This means, that according to further development, the public digital signature encryption is correlated to the private digital signature encryption, which allows a validation of the signature process in a known manner.

It is especially preferred, that the output signal (especially when in the form of an output value) is formed as a part of the electronic document to be signed; in that case, the user receives an immediate reply by notification of the output value together with the relevant document, that only this specific electronic document, as requested by the user, has been signed, and not another hidden one.

As mentioned before, an especially secure realization form of the present invention is one, where the input unit is a direct part of the signature creation unit, where security can be increased by the fact, that through relevant technology of the signature creation unit no physical or logical connection to the data processing unit is possible, where in the following “no physical or logical connection” is understood as the missing ability of a data processing unit to process direct data operations on a separate external data processing unit, without further manual intervention. Correspondingly, a danger from a virus within the data processing unit or such can be intercepted.

It is also preferred, to construct the output signal in the form of an output value, so that it can be set or influenced manually by the input unit (and thus the user). This is especially valuable in a case, where the signature creation unit (in the form of a typical smart card) is contained within a card reader and thus cannot be read by a user during the signature process. The user could then input that pre-selected output value or comparative value into the card reader separate from the data processing unit and thus enable a secure functioning of the signature unit in the framework of the present invention. With the start-up software for the smart card it cannot always be assumed, that these smart cards offer an input possibility for a corresponding value. In such a case, a single input can produce a response for a signal through the output value or comparative value, so that it can be transmitted by the smart card to the user, and thus passed on over the input intersection of the data processing unit to the smart card for validation. The confirmation of the validity can be done visually or acoustically over the smart card by means of a simple confirmation key or cancellation key.

It is also preferred in the framework of the present invention, to increase security by the input unit registering biological user identifying characteristics, such as fingerprints or voice recognition which are in the developing stages of the technology.

Preferred further developments of the invention include the physical separation of the input unit from the signature creation unit. In view of future general increase in wireless data transmission protocols in the local area, e.g., Bluetooth or PAN (Personal Area Networks), it could be recommended to realize the back coupling loop to the user by means of a wireless input unit, where it can be done alternatively over an available mobile telephone (perhaps through brief notification). Independent protection in the framework of the present invention, in combination with the first aspect of the invention described previously is claimed for a solution according to the independent claim 9, namely the security increasing provision of a multitude of private digital signature encryptions, and not only for different persons or sessions, but as intentional redundant basis provided with choices for one and the same signature process. In this way, misuse is avoided by a necessary (correct) choice of the right private digital signature encryption from a number of them, where, according to the invention, the provided digital parameter of this correct choice is the basis. Typical configurations of the digital parameter are number codes or digital scripting, where they can be input externally (by a user), or produced by different pre-set mechanisms; an example only is the production by means of random numbers, by means of a session key, a production within a client server dialogue, etc. where especially dynamically produced scrip tings can be imagined, which are stored and run on a script run environment within the signature creation unit.

Special importance within the framework of the present invention lies in those digital parameters, which are chosen or determined time-dependent, which typically leads to having to use unambiguously selected signature encryption within predetermined or dynamically determined time windows for legal digital signature (and selected in relevant manner according to the invention by means of the selection unit). A person misusing the system faces a significantly complex problem, having to construct the respective selection reference besides a disclosure (given by the calculation from the public signature encryption) of additionally the private digital signature encryption within the time-dependent window. This has practical relevance within the client-server environment in further development, where the server unit provided in further development is planned for such a confirmation dialogue (and has received the relevant digital parameters as well as the time signal for this purpose), while this digital parameter and the time signal, respectively, is not transparent to the inquirer. In other words, without knowledge of such a correct time linkage, even the successful disclosure of the private digital signature encryption would expose the misuse, where especially the security of the server provided in further developments can be increased, so that repeated inquiries concerning the same digital signature with their time parameters can be caught as misuse.

Security can be potentially increased within the framework of this aspect of the invention, by deleting from the signature creation unit such digital parameters (or even private digital signature encryptions from a number of private encryptions), which have a past reference, i.e. documents relevant for security purposes have been used, whose signature point in time is in the past. By deleting and removing such parameters and the associated private encryptions, respectively, a later access to these encryptions and thus a digital back-dating becomes impossible due to the private encryptions and their associated selection parameters, respectively, being unavailable (even when theoretically each private encryption can be reconstructed from the public encryption, this does not apply to the parameter according to the invention).

Additionally, the sequence of the signature encryptions or their addressing, with which these encryption data are stored in the signature encryption storage, or the procedure or the internal names, or the internal values within a parameter interpretation unit, which are authorized for the conversion of the parameter, are set by the parameters according to the invention or calculated in a pre-set, security enhancing manner. Although the order or addressing, respectively, of a number of signature encryptions have a standardized order, and as the procedure and the name of the functions are standardized in the parameter interpretation unit, a deviation can be due to an additional secret transaction, perhaps arranged with another receiver or neutral server, and can thus be used for other purposes, such as deposit at a neutral location, such as the parameter server or hash value server.

The basic idea of linkage of a digital signature with an objective signal, not subject to an additional data-based synchronization or data exchange, is found in a further aspect of the invention according to the independent patent claim 14, namely the distribution according to the invention of the digital signature created in the usual way together with the objective time signal in the signature status server unit according to the invention. This aspect of the invention is based on the idea, that, even when the private digital encryption is solved by appropriate data manipulations, the connection to the objective time signal, perhaps at the point in time of signature and/or creation of the document, remains non-transparent to the unauthorized user. Additionally, according to the invention, the digital signature receives a clear time or age range, respectively, by distribution in the secure signature status server unit, so that even a private signature encryption, which was cracked successfully and then is used unlawfully for a digital signature, receives a later and thus potentially suspicious time range in the signature status server unit.

The basic idea in the use of different algorithms can also find an application in the additional creation of a data-based expansion for the existing hash value and storage within the signed document. The knowledge about the additional algorithm change parameter can thus be used as additional proof for the authenticity of a signature, where the creation of this additional hash data can be done separate from the normally displayed signature data. If these parameters together with their significance for the variation of the hash algorithm are stored on a external neutral server, this server can then calculate the confirmation or non-confirmation output during proofing and validation of the signature without disclosing the parameter. Additionally, such a procedure has the advantage, that there is no possibility to decide by algorithm, which algorithm change parameter was used, which would set clear and previously not available limits to an attack by means of a quantum computer.

In view of user friendliness of such an infrastructure, it is thinkable, to transact not only the invention-based protocol over the provided server unit, but especially to provide the complete documents, by creating for it the necessary user identification and authorization infrastructure in the normally known manner.

Especially significant are further developmental means, to supplement the electronic document signed and thereby secured by time and/or text components; the user has thus the possibility, to add to his electronic document for additional security perhaps a creation time notice and/or text references (perhaps in the form of liability limiting references or such) and/or additional structure or attribute data signed and therefore secured, so that the possibility exists, to define attributes locally (i.e. immediately on the encryption creation unit), free from subsequent manipulation, and to add it to the electronic document. These limits, created in text, which are otherwise only contained in the attributes of a certificate separate from the signed document, provide additional security in offline use, namely the use of the digital signature, if there is no immediate contact to a certificate index, created or available online, or the certificate server.

Another aspect of the present invention, for which independent protection is required, but which can be realized in connection with further aspects of the invention as preferred construction form, concerns the complexity- and thus security enhancing multiple use of the private digital encryption(s) by means of parameter control one after the other or in recursive manner, respectively: thus it is provided within the framework of the invention, on the basis of operating parameters, to execute a multiple encryption of the electronic document or the characteristic signage string, respectively, by considering further aspects and parameters, so that, even with the background of a possible calculated decoding of the digital signature, complexity can be significantly increased: the disclosure of a private encryption (or of several private encryptions) from associated public encryptions does not lead automatically to the digital signature; additional operating parameters have to be known or deducted from the signed document or external servers, respectively, which only then lead to the invention-based complex digital signature result. The correctness of the operating parameters cannot be immediately deducted either from the digital signature result nor from the public encryption.

In the end result, the present invention produces a drastic increase in security and thus also long-time application of the generic-based encryption process, especially with the normally used asymmetrical encryption context, without having to fear, that hidden attacks from a (always insecure) user side or future computer calculations with their unknown potential will nullify the security maintaining attributes.

### BRIEF DESCRIPTION OF THE DRAWINGS

FIG. 1 is a schematic block diagram of a device according to one embodiment of the invention.

### DETAILED DESCRIPTION OF THE INVENTION

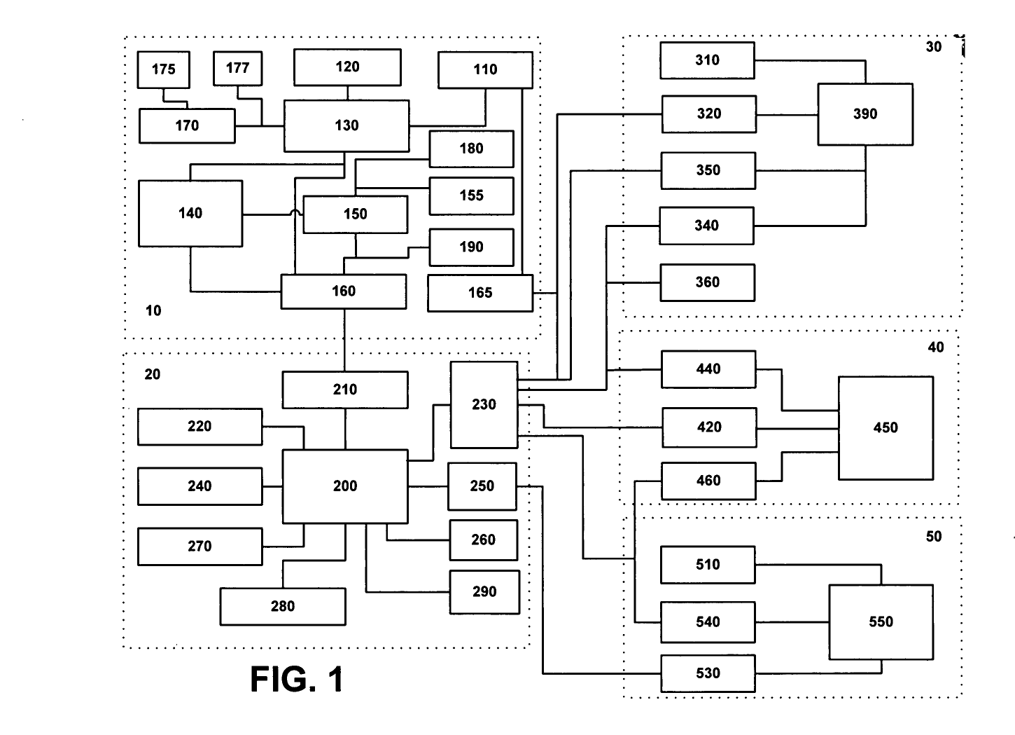

Additional advantages, characteristics and details of the invention can be seen in the following description of preferred construction samples as well as from the diagrams; these show in FIG. 1 a schematic block wiring diagram as an overview of a device according to the invention according to the first preferred construction form, which is suitable for the implementation of all suitable invention additions. The present invention includes the possibility to combine various function blocks and characteristics within the framework of the present invention, without having to fulfill the realization form shown in FIG. 1 in its totality.

The meaning and manner of functioning is seen in the subsequent table for identification of the designations with their associated function groups; as can be seen from the figure, a smart card (10) communicates as signature creation unit within the framework of the described construction form with a PC unit (20) as user-side data processing unit, as well as several, typically Internet connected server units, especially a Certified Authority (30) as invention-based certification unit for the preparation of the certificates and the public signature encryption associated with them, respectively, also a hash server unit (40) as signature status server unit in the sense of the invention, as well as a parameter server unit (50) as server unit provided for receiving of digital parameters and the time signal realized within the framework of the invention.

Corresponding to the numbering given in FIG. 1, the following table gives a description of the meaning and summary of the units contained within them.
10 Smart card unit/secure storage and processing unit (signature creation unit)
20 PC unit (local data processing unit)
30 Certified authority (CA) signature creation or administration unit
40 Hash server unit (signature status server unit)
50 Parameter server unit
110 Private encryption storage unit
120 Parameter storage unit
130 Parameterized encryption selection unit
140 Signing processor unit
150 Text preparation unit
155 Text limit library unit
160 Smart card—PC interface unit
165 Smart card—CA interface unit
170 Random number creation unit
175 Random number output unit
177 Random number input unit
180 Local time stamp unit
190 Smart card identification unit
200 CPU unit
210 Smart card reader unit
220 Display unit
230 Network interface unit
240 Document storage unit
250 Parameter interface unit
260 Local parameter creation unit
270 Local time signal unit
280 RAM storage unit
290 Random value input/confirmation input
310 Encryption pair creation unit
320 Certificate transmission unit
340 Certificate validation inquiry unit
350 Certificate index
360 Server-side certified time signal unit
390 Certificate creation unit
420 Hash value receiver unit
440 Hash value inquiry unit
450 Hash value index
460 Hash value-parameter-interpreter- and/or evaluation unit
510 Server-side parameter creation unit
530 Parameter interface unit
540 Parameter inquiry unit
550 Parameter storage index

The smart card unit (10) contains a unit for secure storage (110) of private encryption data as a secure storage and processing unit for private encryption data or as signature creation unit, respectively. Within the framework of the invention an owner of a smart card can be sent several equivalent private encryptions in the storage unit (110) for the invention-based use by the certification unit (30), or the user can request these encryptions from the certificate server at a later point in time in order to increase security, and receive them encrypted and protected. For the protected transmission of encryption data or for communication with a certificate server an especially protected interface unit (165) can be provided, which furnishes longer encryptions or, if need be, additional secret identification and authorization data for data to be exchanged, which can be retrieved from the smart card identification unit (190).

In the smart card (10) the electronic documents are transmitted by the data processing unit over the PC-smart card interface unit (160) provided for this to the smart card, so that the secret signature encryption data can be applied to the document to be signed by means of a standardized and pre-determined signing algorithm only within the protected signing processor unit (140). The smart card (10) can identify and authorize itself against programs installed on the PC unit by data, Which are present within the smart card identification unit (190).

The private encryptions stored in the encryption storage unit (110) are selected before their use in the signing processor unit (140) by an encryption selection unit (130) in such a way, that only a single private encryption is transmitted to the pre-determined signing algorithm by means of parameters which are used in the unit (130) during selection.

In a further construction form of the present invention, the parameterized encryption selection unit (130) can be applied to document range-specific parts of a document by means of determined parameters, or can be applied in a parameter-controlled manner within the pre-determined signature encryption to several encryptions stored in the encryption storage unit. Additionally, the encryption selection unit is capable of adding parameter-controlled signage strings of a content to be signed before or after the digital signing.

The additional parameters are stored in the parameter storage unit (120) and can be retrieved by the encryption selection unit in a pre-determined manner, or they can be offered by the parameter storage unit (120) by providing a natural serial sequence. The parameters used in the smart card can be generated either locally within the random number creation unit or can be provided by an external source such as the parameter server unit (50) over protected network interfaces (230) or (165), respectively. In the same way, the locally produced parameters or the received, but modified parameters can also be sent to the parameter server unit (50) in a protected way.

According to the invention, before the signing of a document, a random signage string, but with determined length, is produced in the random number creation unit (170) from a pre-determined signage supply, which is transmitted to the user by the output unit (175). The user enters the transmitted signage string in the input unit (177), signals by pressing a confirmation key, that a new digital signing of a task, characterized by a new random value, can be initiated.

The validation of the correctness of the entered value or the confirmation by the user in (177), respectively, takes place in the signature processor unit (140), so that this unit processes or denies the signature corresponding to the result produced hereby, whereby this decision can also be displayed on the output unit (175).

Additionally, a local time stamp unit (180) can be contained in the smart card, where time signals are produced independently from user input or input from the data processing unit that can be manipulated. This time stamp unit (180) can also have means for reception or synchronization with external time signal transmitters. The data generated within the time stamp unit (180) can be added within a text preparation unit (150) as additional data within a document before or after the signing, or these data can be used as parameters in the encryption selection unit (130). Additionally, the time stamp unit can display the actual time on the output unit (175).

In a further construction form of the invention, text, such as e.g., limiting the validity of a signature (such as the legal or economic competence of the signature owner or such), can be stored as text in a library unit (155) for limiting texts and can be inserted or added to the text preparation unit according to pre-determined rules.

Additionally, the output unit (175) can be constructed in such a way, that it displays the electronic document or parts of the document to be signed or essential data, such as structure or meta data or text or time stamp data which were added in the unit (150).

Since smart cards or signature creation units are planned in direct cooperation with local data processing units such as normal PCs (20), these PC units have to show a card reader unit (210) adapted to the smart card. The documents intended for digital signature are retrieved from the local data storage unit (240), can be displayed by the local display unit, and can be changed by programs, which change the documents in the local RAM storage unit (280) by means of the central processor unit (CPU) (200), where the digital signing is done on the smart card due to security reasons, but can also be done on the PC unit. By creating a digital signature on the PC, a local parameter unit (260) and a parameter interface unit (250) on the PC in contact with the parameter server (50) can be available on the PC. The creation of the signature for the document to be signed and the selection of the encryptions is then done on the CPU (200), where the encryption data are retrieved from the RAM.

The data processing unit can be used as interface to the data transmission network by means of the network interface (230) and can thus receive or also send data, which are encrypted and protected, from the hash server unit (40) or the parameter server unit (50).

The parameters contained in the smart card can also be produced in the local data processing device within the local parameter creation unit (260) and transmitted to the smart card. The entry of the random value as confirmation input (290) over the input unit (270) connected to or contained in, respectively, the local data processing device, where in this case it has to be ensured through output on the output unit (175) of the smart card, that only the document is to be signed, that the user of the PC unit has given it to the smart card for signing, and, if needed, has viewed it previously on the local display unit (220) or opened it for visual comparison, respectively.

To validate the time of signing of a document, the local PC unit can also have a timer (270).

The smart cards are physically produced by a Certified Authority (CA) and provided with a private signature encryption. The CA (30) is also authorized for the administration, storage, distribution and correct responses to inquiries to the public encryption data.

Thus the CA contains an encryption pair creation unit (310) and a certification transmission unit (320), which produce the smart cards, which are sent by normal mail (registered) to the recipient and future owner of the smart card. Additionally, according to a construction form of the invention, confidential encryption data can be transmitted to the smart card over the internet, where special security characteristics of the smart card, such as the unique smart card identification and authorization data, can be used, in order to enable a connection between the smart card and the encryption pair creation server, which cannot be intercepted. In the CA unit (30) a so-called certificate is produced in addition to the encryption pair, of which the public part is published in relevant indices (350), or the public part of which can be given or transmitted with the document by the owner of signature as proof or sign, respectively, of authenticity, where a validation by a certificate index further increases the credibility of a certificate.

The certificate index (350) also contains data, which offer the possibility to any interested party during an inquiry concerning validity of a signature or a certificate at a certificate validity inquiry unit (340) and to transmit a non-confirmation or confirmation signal, without having to give the inquirer secrete or confidential data.

The hash server unit or the signature server unit (40) is able to deposit associated time signals as well as smart card identifying data in addition to the digital signature data or hash data in a hash value index (450). The data are received from the hash value receiver unit (420) in a protected and encrypted manner, and are prepared for publication in the relevant indices. The hash value inquiry unit (440) as well as the hash value parameter interpreter and/or evaluation unit can make data from the index (450) available to inquiries in such a manner, that the secrete and confidential data in the index cannot be accessed by a third party or that they cannot be altered by a potentially dangerous interaction with hackers.

The parameter server unit (50) produces secrete and confidential parameter values for the smart card of a client in the server-based parameter creation unit (510); these parameters can be transmitted or called up by the client by means of a parameter interface unit (530) in protected and encrypted form to the parameter interface of the client.

The parameter inquiry unit (440) as well as the parameter interpreter and/or evaluation unit can make data from the parameter storage index (550) available to inquiries in such a way, that the secrete and confidential data contained in the index are not made available to a third party or that they can be altered by interaction with hackers.

The signing of a document by using the parameters can be done in a significantly complexity increasing way, when a digital document can be divided into separate or overlapping segments. These document segments form the document ranges, for which the parameters can be used in a document range specific manner. Individual segments of an electronic document can be signed by a single signature encryption that is changing to another segment, or by a parameter controlled use of a pre-determined series of signature encryptions within a complexity increasing document range specific and parameter controlled manner. Another concrete application of these parameters can thus be seen in the partitioning of a document; in a manner of the partitions building upon each other, separate or subsequent signings of the individual parts are done in a controlled manner, described by algorithms, which use parameters. These processes have in common, that the relevant parameters are sent in encrypted manner to the corresponding parameter server there they are evaluated during inquiries or sent to other servers for evaluation.

In this framework there is another possibility for evaluating the correctness of parameter-based signatures; all relevant data, as well as signed content, signatures, certificates and parameters are transmitted to a neutral unit, which executes the application of the parameters in the proscribed manner without attempt at manipulation like a court obligated to neutrality, and which subsequently makes a determination about the validity of the signature. This unit can also be operated independently from the server, where only the additional parameters but not the private encryptions of the signature creator have to be disclosed.

Within the framework of the invention, even the renewed entry of a PIN code cannot lead to a result, which can be useful for a hacker, since a new PIN code is produced by the smart card, which can tell the owner by the output unit associated with the smart card, if the correct PIN code was entered or not. This prevents, that the input mask on the PC or on a certified smart card reader was manipulated in such a way, that it can be used by a virus, to sign a document in a covert manner.

In order to further increase the security, the smart card can indicate the document to be signed before the signature over another interface, which is physically and logically separated from the data processing device, such as e.g., wireless communications tools such as Bluetooth or an independent and uncontrolled output medium such as e.g., a PDA. Additionally, the entry of the authorization code or confirmation signal can proceed only after display on an independent output or input station, so that a hidden authorization not intended by the user is already impossible, since each authorization is valid for only one set of data. On the other hand, it is evident, that without a corresponding manual authorization loop a signing can have already taken place, and that a corresponding document can have been transmitted over the internet in a non-executable manner.

The present invention is not limited to the described construction forms; thus it is possible to provide especially the respective server units locally or within another connection context, respectively, and, as already shown, the signature creation unit is not at all limited to the described module or card-like realization form.

1. A device for digital signature of an electronic document by means of a signature creation unit, which is portable and in the form of a card and protected against manipulation,
which is planned for cooperation with a data processing unit for providing the electronic document to be signed and for receiving the digital signature,
and which is constructed to deposit the secret, hacker-protected private digital signature encryption, where through a signature processor unit of the signature creation unit the digital signature can be produced on the basis of a signage string characteristic for the electronic document as well as the private digital signature encryption,
characterized by,
the signature creation unit showing an output unit for giving an output signal for a user of the data processing unit, which cannot be influenced by the data processing unit,
an input unit being associated with the signature creation unit, which can be confirmed by the user, and
the signature creation unit being formed in such a way, that as a response to the output signal a user input into the input unit is required, before the digital signature is created and/or transmitted to the data processing unit.

2. A device according to claim 1, characterized by a public digital signature encryption, provided by a certification unit preferably being connected by a data transmission network, being associated with the private signature encryption, which enables the validation of the private signature encryption by comparison of the characteristic signage string with the digital signature, to which the public digital encryption has been applied.

3. A device according to claim 1, characterized by an output value, corresponding to the output signal and entered into the input unit by the user, being part of the electronic document and being able to be displayed with it after the digital signature was accomplished, or being a part of the output signal of the electronic document, to which the private signature encryption was applied.

4. A device according to one of the claim 1, characterized by the input unit being a part of the card and/or module-like signature creation unit or a part of a further data processing unit, and not having a direct physical or logical connection to the data processing unit.

5. A device according to claim 4, characterized by an output value of the output unit as output signal being able to be set or influenced by the input unit and/or the output unit being connected to the signature creation unit by means of a wireless application, especially over a microwave or light-based connection.

6. A device according to claim 4, characterized by the input unit being constructed for reception of bio identification characteristics, especially for fingerprints, voice or retina of a user.

7. A device according to claim 1, characterized by the input unit being physically separate from the signature creation unit.

8. A device according to claim 7, characterized by the input unit being connected to the signature creation unit over a wireless application, especially a microwave or light-based connection.

9. A device for digital signature of an electronic document by means of a signature creation unit, which is portable and in the form of a card and protected against manipulation,
which is planned for cooperation with a data processing unit for providing the electronic document to be signed and for receiving the digital signature and which is constructed to deposit the secrete, hacker-protected private digital signature encryption, where through a signature processor unit of the signature creation unit the digital signature can be produced on the basis of a signage string characteristic for the electronic document as well as the private digital signature encryption,
characterized by,
the signature creation unit being formed for storage of a number of private signature encryptions for the same signature process, and the signature creation unit having a selection unit for selection of one of the numbers of private digital encryptions before creating the digital signature, where the selection unit executes the selection as response to one of the digital parameters provided by a parameter storage unit.

10. A device for digital signature of an electronic document by means of a signature creation unit, which is portable and in the form of a card and protected against manipulation,
which is planned for cooperation with a data processing unit for providing the electronic document to be signed and for receiving the digital signature and which is constructed to deposit the secrete, hacker-protected private digital signature encryption, where through a signature processor unit of the signature creation unit the digital signature can be produced on the basis of a signage string characteristic for the electronic document as well as the private digital signature encryption,
characterized by,
the signature creation unit being formed for parameter-controlled application of at least one private digital signature encryption a number of times to the characteristic signage string and/or further signage strings, which are dependent on it or connected to it, where the operating parameters controlling the application provided by an operating parameter storage unit can be generated from data of the electronic document or by a time signal unit or can be input or output externally
and a result of the parameter-controlled application can be inserted into a data range of the electronic document before a concluding signing.

11. A device according to claim 10, characterized by a public signature encryption, provided by a certification unit preferably over a data transmission network, being associated with each of a number of private signature encryptions, which enables a validation of the private digital signature encryption by comparison of the characteristic signage string with the digital signature, to which the public signature encryption has been applied.

12. A device according to claim 10, characterized by the digital parameter being selected or determined in a time dependent way and a corresponding time signal being able to be produced either by a time stamp unit of the signature creation unit or by an external timer.

13. A device according to claim 12, characterized by the digital parameter and the time signal being deposited and available for validation purposes on an external server unit, preferably connected over a data transmission network, where the server unit reacts as response to a validation inquiry concerning a digital signature with a confirmation signal, without providing the digital parameter to the inquirer.

14. A device according to claim 11, characterized by the signature creation unit having means for deleting of such digital parameters, which have a time dependency to the past for the deletion point.

15. A device for digital signature of an electronic document by means of a signature creation unit, which is portable and in the form of a card and protected against manipulation,
which is planned for cooperation with a data processing unit for providing the electronic document to be signed and for receiving the digital signature
and which is constructed to deposit the secrete, hacker-protected private digital signature encryption, where through a signature processor unit of the signature creation unit the digital signature can be produced on the basis of a signage string characteristic for the electronic document as well as the private digital signature encryption,
characterized by,
means being provided for deposit of the digital signature together with an objective time signal and especially with further data in a signature status server unit preferably connected over an electronic data transmission network, which is protected against manipulation and formed as a storage unit.

16. A device according to claim 15, characterized by a public digital signature encryption being associated with the private digital signature encryption, provided by a certification unit preferably connected over a data transmission network, which allows a validation of the private digital signature encryption by comparison of the characteristic signage string with the digital signature, to which the public signature encryption has been applied.

17. A device according to claim 16, characterized by the signature creation unit being formed for additional availability of original data of the electronic document, of compromised or encrypted original data or of structural data associated with the original data, where preferably means for access are provided for this purpose.

18. A device according to claim 1, characterized by a time stamp unit as part of the encryption creation unit, which is provided for producing a digital time signal or for means for receiving a digital time signal and for adding the digital time signal, signed by the digital private encryption, to the electronic document before signing.

19. A device according to claim 1, characterized by a text construction unit as part of the encryption creation unit, which is provided for the creation of digital text addition and for adding the means of the digital text addition, signed by means of the digital private encryption, to the electronic document before signing.

20. A device according to claim 15, characterized by the means for storing of the digital signature and especially of further data, preferred parameters or time signals being able to be executed on the signature status server unit by the signature creation unit or by the data processing unit, or being executed over structure or metadata within the document as instructions to a document administration unit.

21. A device according to claim 15, characterized by the signature status server unit reacting in response to a validation inquiry regarding a digital signature with a confirmation signal, without making the digital parameter stored on the server unit available to the inquirer.

22. A device according to claim 9, characterized by the digital parameters being a calculated document-range specific function, especially applied to segments of an electronic document by an individual signature encryption or a parameter-controlled application of a pre-determined series of signature encryptions, where the document-range specific application is executed by parameter control.
